(19) United States
(12) Patent Application Publication
(10) Pub. No.: US 2026/0049924 A1
(43) Pub. Date: Feb. 19, 2026

(54) FLOW CYTOMETER

(71) Applicants: Gerrit Jan van den Engh, Concrete, WA (US); Bigelow Laboratory for Ocean Sciences, East Boothbay, ME (US)

(72) Inventor: Gerrit Jan van den Engh, Concrete, WA (US)

(73) Assignee: Bigelow Laboratory for Ocean Sciences, East Boothbay, ME (US)

(21) Appl. No.: 18/804,763

(22) Filed: Aug. 14, 2024

(51) Int. Cl. G01N 15/1434; G01N 15/14; G01N 15/1404; G01N 15/149

(52) U.S. Cl. CPC G01N 15/1434; G01N 15/1404; G01N 15/1459; G01N 15/149; G01N 2015/1413

(57) ABSTRACT

A flow cytometer is disclosed. The flow cytometer may comprise a nozzle with an orifice, the nozzle configured to eject fluid from the orifice along a flow path. In some embodiments, the flow cytometer comprises a sensor assembly configured to capture one or more optical signals of one or more particles in the fluid while the one or more particles are disposed at or upstream of the orifice.

### FIELD

The field is related to flow cytometers configured to measure optical signals of particles.

### GOVERNMENTAL SUPPORT

This invention was made with Government support under Grant No. OCE-1829879 awarded by the National Science Foundation. The Government has certain rights in the invention.

### BACKGROUND

Flow cytometers conventionally measure optical signals (e.g. fluorescence and scatter) emitted by particles that are moving through a field (Light Field) using a cytometry sensor assembly. Such a cytometry sensor assembly generally comprises a light source (e.g. a laser), and at least one detector configured to measure optical signals. In operation, the particles are contained at the center of a fluid jet that emanates from a small orifice in a nozzle. The optical signals from the particles are registered after the particles exit the orifice in the nozzle by the detectors that are arranged in a plane orthogonal to the direction of flow. The detector pulses are digitized and stored. The digital values associated with a particle crossing the Light Field (i.e. an Event) provide numerical information about the identity and properties of the particles.

Improved flow cytometers are needed.

### SUMMARY

According to some embodiments, a flow cytometer is disclosed, the flow cytometer comprising a nozzle defining an interior volume and comprising an orifice at a distal end of the nozzle, the nozzle configured to eject fluid from the interior volume of the nozzle through the orifice along a flow path, the fluid comprising a plurality of particles, and a sensor assembly configured to capture one or more optical signals of one or more of the particles while the one or more particles are disposed at or upstream of the orifice.

According to some embodiments, a method of measuring optical signals of particles is disclosed, the method comprising moving fluid through a nozzle defining an interior volume and comprising an orifice at a distal end of the nozzle, the nozzle configured to eject fluid from the interior volume of the nozzle through the orifice along a flow path, the fluid comprising a plurality of particles, capturing, using a sensor assembly, one or more optical signals of one or more of the particles while the particle is at or upstream of the orifice, and ejecting the particle from the nozzle, through the orifice.

According to some embodiments, in a flow cytometer configured to eject a plurality of particles from an orifice of a nozzle and improvement to the flow cytometer is disclosed, the improvement comprising a sensor assembly configured to measure one or more optical signals of a one or more particles of the plurality of particles while the one or more particles is disposed at or upstream of the orifice.

According to some embodiments, a flow cytometer is disclosed, the flow cytometer comprising a nozzle defining an interior volume and comprising an orifice at a distal end of the nozzle, the nozzle configured to eject fluid from the interior volume of the nozzle through the orifice along a flow path, the fluid comprising a plurality of particles, and a sensor assembly disposed at a proximal end of the nozzle opposite the orifice, the sensor assembly configured to capture one or more optical signals of one or more of the particles.

### BRIEF DESCRIPTION OF THE DRAWINGS

The following drawings form part of the present specification and are included to further demonstrate certain aspects of the present disclosure, which can be better understood by reference to one or more of these drawings in combination with the detailed description of specific embodiments presented herein. It is to be understood that the data illustrated in the drawings in no way limit the scope of the disclosure.

FIG. 1 shows a schematic representation of a portion of a flow cytometer according to an embodiment of the present disclosure.

FIG. 2A shows an arrangement of optical components and resulting image rays of the embodiment of FIG. 1.

FIG. 2B shows an arrangement of optical components and resulting collimated trigger beam of the embodiment of FIG. 1.

FIG. 2C shows an arrangement of optical components and resulting image rays and collimated trigger beam of the embodiment of FIG. 1.

FIG. 3 shows a timing diagram for the flow cytometer of FIG. 1.

### DETAILED DESCRIPTION

The inventors have recognized that, in some embodiments, it may be useful to capture at least optical signal (e.g., images) of an Event to complement the numerical information measured by the detectors of the cytometry sensor assembly. The current art of generating optical signals of the particles in a flow cytometer is to place a measuring device (e.g. a camera) in the same orthogonal plane where the detectors of the cytometry sensor assembly are located, post-ejection from the orifice. Signal collection while observing a moving particle from an orthogonal direction presents considerable technical challenges, particularly for images.

For example, the orthogonal plane is already crowded with of the cytometry sensor assembly, presenting spatial limitations due to various components competing for space.

Additionally, the particle moves orthogonal to the direction of observation, and the resulting images will therefore be blurred, particularly at the high speeds which particles may be moving at (e.g., 10 m/s). Blurring correction requires technically sophisticated, and expensive engineering solutions. The focus of images may be sharpened either by using a short exposure time which requires fast, sensitive, and therefore expensive cameras, or with a digital sensor in which the row of collection pixels can move in step with the projected image. Both solutions are costly and technically difficult. In addition, some of these solutions can reduce the quality of other signals of the particles.

Additionally, it may be desirable to include a particle sorter with the flow cytometer. However, implementation of optical components of the imaging system post-ejection from the orifice for image collection surrounding the jet interfere with components for droplet generating and monitoring, and therefore prevent the use of the instrument as a particle sorter. To the knowledge of the inventors no currently available cell sorter can capture high-quality images of the sorted particles. Instead, these cytometers use a cuvette disposed around the jet to improve imaging, but this frustrates the ability to sort particles. For example, BD Cell View Image Technology utilizes convoluted and expensive laser array technology to create a large number of light spots inside the jet, and deconvolute signals from those light spots to determine the size and shape of the particle. See https://www.bdbiosciences.com/en-us/learn/applications/cell-view-image-technology#Technology. Similarly, BD S8 Cell Sorter with BD CellView Image Technology uses a glass cuvette around the beam, which frustrates cell sorting because particle velocity and timing of sort drops varies as a function of distance from the wall. See https://www.bdbiosciences.com/en-us/products/instruments/flow-cytometers/research-cell-sorters/bd-facsdiscover-s8. Other systems are only suitable for larger particles. See Copass Vision, https://www.unionbio.com/copas-vision/.

In contrast, the presently disclosed flow cytometers allow for sorting of particles downstream of the orifice while allowing both particle sorting and analyzing properties of sorted particles that are associated with another particle property (e.g., an image).

Importantly, the disclosed flow cytometers use two optically independent systems that can implement the traditional precision of jet and air systems to measure particles of a wide array of sizes. In some embodiments, the optically independent systems can operate in a synchronous fashion. The disclosed systems accordingly can obtain multiple measurements of particles that do not interfere with one another, as the signal of a particle post-ejection from the orifice of the nozzle does not interfere with the upstream sensors. These systems are also advantageously open to any kind of analysis, either before or after ejection from the orifice.

The inventors have therefore recognized an advantage to configuring a sensor assembly to measure optical signals of a particle while particles are upstream of the orifice of the nozzle. In some embodiments, the sensor assembly is oriented approximately axial to a flow direction of the fluid containing the particles. In some embodiments, the sensor assembly is a cytometry sensor assembly. In some embodiments, the sensor assembly is an imaging system, and the optical signals comprise images. In some embodiments, a flow cytometer comprises only a single sensor assembly, which is configured to measure optical signals of a particle while the particle is upstream of the orifice of the nozzle. In some embodiments, a flow cytometer comprises both a cytometry sensor assembly and an imaging system, with one of the cytometry sensor assembly or imaging system configured to measure optical signals of particles while particles are disposed upstream of the orifice of the nozzle. The optical signals measured can be any signals conventionally measured in the field of flow cytometry, including, but not limited to fluorescence or scattering. Combinations of optical signals can also be measured prior to ejection from the orifice, as sensors, detectors, and cameras can all be used to measure signals pre-ejection.

In some embodiments, a sensor disposed distal from the orifice focuses on the tip of the interior of the nozzle, leaving the remainder of the particles in the interior of the nozzle out of focus. In some embodiments, the object field is illuminated. In some embodiments, the object field is illuminated by a concentrated light field proximal to the orifice in the interior of the nozzle. In some embodiments, the light field is configured to only illuminate a single particle as it passes through the object field. In some embodiments, a parallel light beam is split by a lens to provide a focusing light beam and an illuminating light beam spatially separated by optics on the portion of the nozzle distal the orifice.

### EXAMPLES

### Example 1

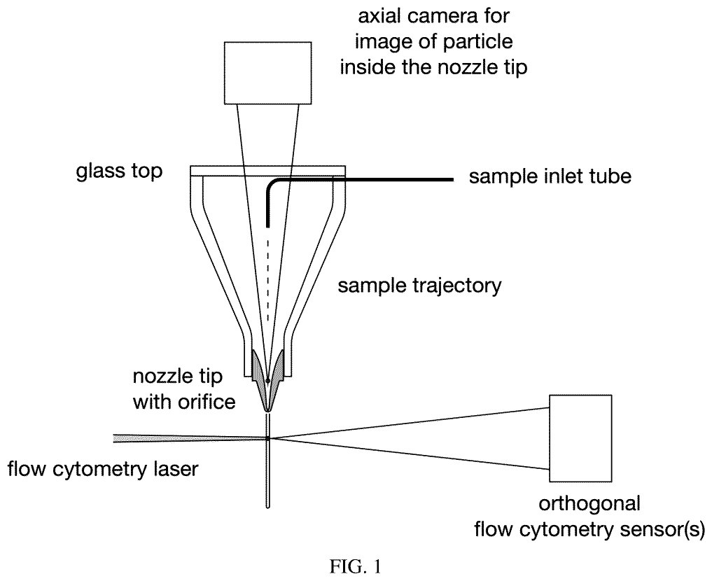

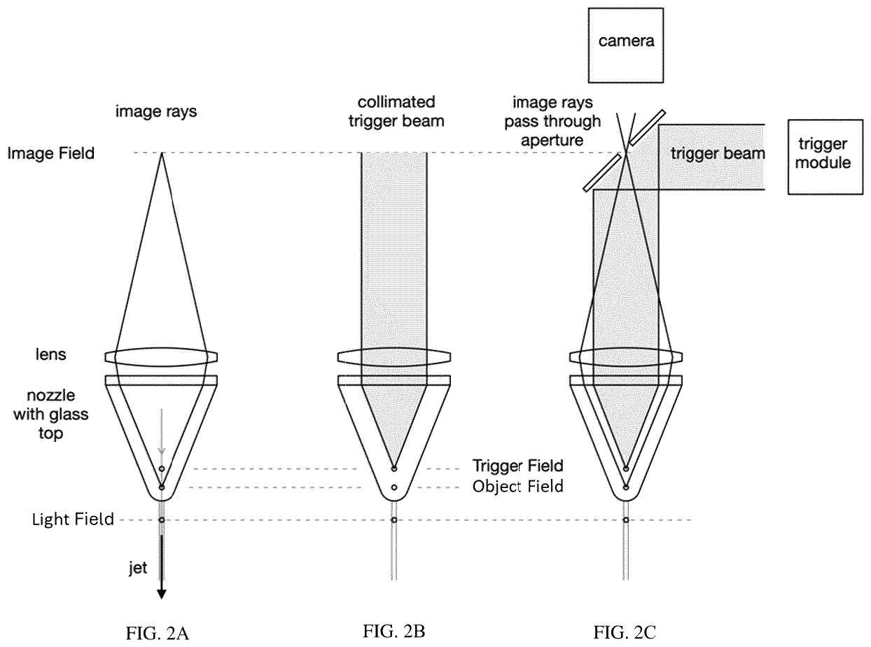

FIGS. 1 and 2 illustrate schematic representations of a flow cytometer according to an embodiment of the present disclosure. This embodiment presents a configuration in which the imaging is performed inside the nozzle cavity. Observation in this arrangement is less challenging than traditional observation at the Light Field in the jet because the flow of the fluid inside the nozzle is slower than that of the jet.

Additionally, according to the embodiment of FIGS. 1 and 2, the imaging is performed along an approximately axial direction of the particle stream. Such a configuration allows the particles move along the axis of observation and stay in focus during the transition through camera's depth of field. This relaxes the blurring constraints considerably compared to the orthogonal observation described above.

The placement of the imaging component on the upstream part of the nozzle does not interfere with a traditional flow cytometry observation and hence does not interfere with conventional droplet sorting. Such a configuration may allow for correlation between images obtained by the imaging component and optical signals measured by the cytometry sensor assemblies used for traditional flow cytometry observation, thus allowing for the construction of an instrument that presents images while still offering the opportunity to verify the result by selecting particles of interest measured by the cytometry sensor assemblies.

As may best be seen in FIG. 2A, the nozzle cavity is wedge-shaped with the nozzle tip pointing downwards. The top is covered with a translucent or transparent top (e.g. glass, acrylic, etc.). A camera placed above the top is focused on the particle stream such that the Object Field of the camera is near the orifice of the nozzle. The placement of the camera above the nozzle does not interfere with the optics that are associated with the Light Field measurement, which are located on the downstream side of the nozzle orifice. In some embodiments, the Object Field is disposed between 0 mm and 5 mm upstream of the orifice. In some embodiments, the Object Field is disposed between 0.5 mm and 1.5 mm upstream of the orifice.

An image of individual particles that pass through the Object Field is collected in two stages. A Lens is positioned above the glass nozzle top such that its focal point is a small distance above Object Field (FIG. 2A). The location of the image that is projected by the Lens is designated as the Image Field. The camera is positioned and focused such that the camera registers the Image Field. Thus, activation of the camera will store a picture of the Object Field that is relayed by via the Image Field.

### Configuring a Trigger Field

In order to better register an image of a particle in the Object Field, the camera trigger may be synchronized with the passage of a particle. Accordingly, an appropriate trigger signal may be provided by creating a Trigger Field upstream of the Object Field. In some embodiments, the Lens may be used for this purpose as well. Alternatively, a separate lens may be used. As may best be seen in FIGS. 2B and 2C, a collimated trigger beam projected through the Lens produces a spot at the focal distance just upstream of the Object Field. Thus, particles flowing along an axial path will first traverse the Trigger Field before they transit the Object Field. Subsequently, the particles will exit the nozzle cavity through the nozzle orifice and enter the Light Field of the flow cytometer/sorting section of the instrument (FIG. 2B). In some embodiments, the Trigger field is disposed between 0 mm and 1 mm upstream of the Object Field. In some embodiments, the Trigger Field is between 0.2 mm and 1 mm upstream of the Object Field.

### Combining the Trigger and Imaging Pathways

FIG. 2C shows how the trigger and image rays may be combined into a single unit.

Such a configuration may allow for a compact, easy-to-align unit. The image rays and the trigger light are combined at the Image Plane that is projected onto the camera's sensor. A mirror with a central aperture reflects the collimated trigger beam. The image rays pass through the aperture towards the camera's sensor. The aperture is slightly larger than the image presented to the camera.

### Illuminating the Object to Be Imaged

In some embodiments, to complete particle image collection, an illumination flash that lights up the object field may be activated shortly after a particle has been detected in the trigger field. The flash may be produced using any suitable light source (e.g. fast LEDs) that illuminates the inside of the nozzle cavity. To increase the exposure light, the inside of the nozzle cavity may be rendered white or reflective.

### Operation of the Flow Cytometer

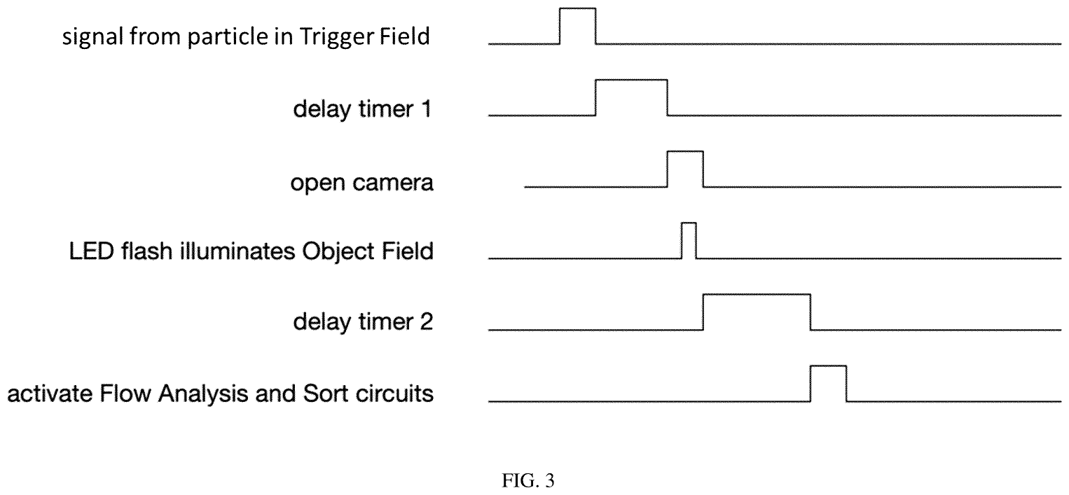

The following describes an exemplary method of operating a flow cytometer according to one or more of the embodiments disclosed herein. As a particle travels through the nozzle, along the flow direction, the particle first encounters the trigger field. As the particle enters the trigger field, the trigger module senses the particle, and sends a signal to the controller to control the imaging system and/or cytometry sensor assembly. For instance, as seen in the timing diagram of FIG. 3, after a particle enters the trigger field, the controller may send a delayed signal to the imaging system to control the camera to capture an image of the particle as the particle enters the object field. In some embodiments, the controller may also control the light source (e.g. the fast LEDS) to illuminate the object field during imaging. The controller may then send a delayed signal to the cytometry sensor assembly to measure the optical signals of the particle as the particle enters the Light Field. In some embodiments, the cytometry sensor assembly may comprise a particle sorter configured to sort the particle during or after cytometry analysis.

While the embodiment of FIGS. 1 and 2 describes a flow cytometer with an imaging system disposed above the conical nozzle and a cytometry sensor assembly configured to measure optical signals after particles have been ejected from the orifice, it is contemplated that either of these systems or assemblies may be placed in either of these configurations, and that either system or assembly may be used in either configuration alone or in combination with the other system or assembly, as the disclosure is not so limited.

Additionally, while the embodiment of FIGS. 1 and 2 describes a flow cytometer with a sensor assembly configured to capture optical signals of a particle along the axial direction of the particle stream, capturing optical signals of particles while the particles are upstream of the orifice is contemplated from any angle relative to the axial direction of the particle stream, as the disclosure is not so limited. Additionally, it is contemplated that a sensor assembly disposed on a side of the nozzle opposite the orifice (e.g. disposed above the top of the nozzle) may be configured to capture optical signals of particles after the particles have exited the orifice, as the disclosure is not so limited.

### OTHER EMBODIMENTS

All of the features disclosed in this specification may be combined in any combination. Each feature disclosed in this specification may be replaced by an alternative feature serving the same, equivalent, or similar purpose. Thus, unless expressly stated otherwise, each feature disclosed is only an example of a generic series of equivalent or similar features.

From the above description, one skilled in the art can easily ascertain the essential characteristics of the present disclosure, and without departing from the spirit and scope thereof, can make various changes and modifications of the disclosure to adapt it to various usages and conditions. Thus, other embodiments are also within the claims. The present disclosure can be illustrated by the following embodiments.

### A1. a Flow Cytometer Comprising:

a nozzle defining an interior volume and comprising an orifice at a distal end of the nozzle, the nozzle configured to eject fluid from the interior volume of the nozzle through the orifice along a flow path, the fluid comprising a plurality of particles; and
a sensor assembly configured to capture one or more optical signals of one or more of the particles while the one or more particles are disposed at or upstream of the orifice.
   A2. The flow cytometer of embodiment A1, wherein the nozzle is configured to hydrodynamically focus the one or more particles prior to ejection from the orifice, and wherein the sensor assembly is configured to capture the one or more optical signals of the one or more particles after the one or more particles have been hydrodynamically focused, but before the one or more particles are ejected from the orifice.
   A3. The flow cytometer any of the preceding embodiments, wherein the sensor assembly is configured to capture one or more optical signals of the one or more particles while the particle is between 0 mm and 5 mm upstream of the orifice.
   A4. The flow cytometer of any of the preceding embodiments, wherein the nozzle comprises a transparent or translucent member disposed upstream of the orifice, wherein the sensor assembly is configured to capture the one or more optical signals of the one or more particles through the transparent or translucent member.
   A5. The flow cytometer of embodiment A4, wherein a surface of the transparent or translucent member is oriented approximately perpendicular to the direction of the flow path.
   A6. The flow cytometer of any of embodiments A4-A5, wherein the transparent or translucent member is disposed at a proximal end of the nozzle opposite the orifice.
   A7. The flow cytometer of any of embodiments A4-A6, wherein the transparent or translucent member is formed from glass or plastic.
   A8. The flow cytometer of any of the preceding embodiments, further comprising a trigger assembly configured to send a signal to a controller to actuate the sensor assembly.
   A9. The flow cytometer of embodiment A8, wherein the trigger assembly is configured to send a signal to a controller to actuate the sensor assembly when a particle passes through a trigger field disposed upstream of the orifice.
   A10. The flow cytometer of any of embodiments A8-A9, wherein the trigger assembly comprises a laser source and a laser sensor.
   A11. The flow cytometer of any of the preceding embodiments, wherein the one or more particles comprises cells.
   A12. The flow cytometer of any of the preceding embodiments, wherein the nozzle is substantially conical or wedge-shaped.
   A13. The flow cytometer of any of the preceding embodiments, wherein the sensor assembly comprises an imaging system configured to capture at least one image of the one or more particles while the one or more particles are disposed at or upstream of the orifice.
   A14. The flow cytometer of any of the preceding embodiments, wherein the imaging system is configured to capture the at least one image of the one or more particles as the one or more particles move from a foreground portion to a background portion of a depth of field of the imaging system.
   A15. The flow cytometer of any of the preceding embodiments, wherein a focal plane of the imaging system is approximately perpendicular to the flow path.
   A16. The flow cytometer of any of the preceding embodiments; wherein the imaging system is configured to capture one or more images of the one or more particles as they move through an object field disposed upstream of the orifice.
   A17. The flow cytometer of any of the preceding embodiments, wherein the imaging system is configured to capture the one or more images as the one or more of the plurality of particles moves through a focal plane of the object field.
   A18. The flow cytometer of any of the preceding embodiments, wherein the trigger field is disposed upstream of the object field.
   A19. The flow cytometer of any of the preceding embodiments, wherein the trigger assembly is configured to trigger illumination means for illuminating the particle in the object field.
   A20. The flow cytometer of any of the preceding embodiments, wherein an interior surface of the nozzle cavity is configured to increase illumination of the object field.
   A21. The flow cytometer of any of the preceding embodiments, wherein the interior portion of the nozzle cavity is white or reflective.
   A22. The flow cytometer of any of the preceding embodiments, wherein the imaging system is configured to capture still images and/or video.
   A23. The flow cytometer of any of the preceding embodiments, wherein the sensor assembly comprises a cytometry sensor assembly comprising a laser configured to interact with a particle of the plurality of particles while the particle is disposed at or upstream of the orifice, and at least one sensor configured to measure properties of the laser after interaction with the particle.
   A24. The flow cytometer of embodiment A23, wherein the at least one property is at least one of the following: forward scatter, side scatter, and fluorescence.

A25. The flow cytometer of any of the preceding embodiments, wherein the sensor assembly comprises a cell sorter.

A26. The flow cytometer of embodiment A25, wherein the cell sorter comprises a charge circuit providing an electrical charge to the fluid; a receptacle positioned to receive one or more cell containing drops formed from the fluid after ejection from the orifice; and a current detection circuit coupled to the receptacle and configured to measure a current in the receptacle.

A27. The flow cytometer of embodiment any of the preceding embodiments, wherein the sensor assembly comprises both an imaging system configured to capture at least one image of the one or more particles, and a cytometry sensor assembly configured to measure one or more optical signals of the one or more particles.

A28. The flow cytometer of embodiment any of the preceding embodiments, wherein the sensor assembly is a first sensor assembly, and wherein the flow cytometer further comprises a second sensor assembly configured to measure one or more optical signals of the one or more particles after the one or more particles have been ejected from the orifice.
A29. The flow cytometer of embodiment A28, wherein one of the first or second sensor assemblies is an imaging system configured to capture at least one image of the one or more particles when the one or more particles are disposed at or upstream of the orifice, and wherein the other of the first or second sensor assemblies comprises a cytometry sensor assembly configured to measure one or more optical signals of the one or more particles.
A30. The flow cytometer of embodiment A29, wherein the first sensor assembly is the imaging system, and the second sensor assembly is the cytometry sensor assembly.
A31. The flow cytometer of any of the preceding embodiments, wherein the flow path is oriented from a proximal end of the nozzle opposite the orifice through the orifice.
A32. The flow cytometer of any of the preceding embodiments, wherein the sensor assembly comprises an imaging system configured to capture images and/or videos of the one or more particles, wherein the imaging system is disposed at a proximal end of the nozzle opposite the orifice.
B1. A method of measuring optical signals of particles, the method comprising:

moving fluid through a nozzle defining an interior volume and comprising an orifice at a distal end of the nozzle, the nozzle configured to eject fluid from the interior volume of the nozzle through the orifice along a flow path, the fluid comprising a plurality of particles; capturing, using a sensor assembly, one or more optical signals of one or more of the particles while the particle is at or upstream of the orifice; and ejecting the particle from the nozzle, through the orifice.

B2. The method of embodiment B1, further comprising hydrodynamically focusing the one or more particles, wherein the capturing of the one or more optical signals of the one or more particles occurs after hydrodynamic focusing but prior to ejection of the one or more particles from the orifice.
B3. The method of any of the preceding embodiments, wherein the capturing of the one or more optical signals of the one or more particles occurs while the one or more particles are between 0 mm and 5 mm upstream of the orifice.
B4. The method of any of the preceding embodiments, further comprising triggering the sensor assembly with one or more particles prior to capturing the one or more optical signals of the one or more particles with the sensor assembly.
B5. The method of any of the preceding embodiments, wherein sensing one or more optical signals of the one or more particles comprises capturing at least one image of the one or more particles with an imaging system.
B6. The method of any of the preceding embodiments, wherein the capturing of the at least one image of the one or more particles occurs as the one or more particles moves from a foreground portion to a background portion of a depth of field of the imaging system.
B7. The method of any of the preceding embodiments, wherein the capturing of the at least one image of the one or more particles occurs as the one or more particles moves perpendicular to a focal plane of the imaging system.
B8. The method of any of the preceding embodiments; further comprising capturing one or more images of the one or more particles as they move through an object field disposed upstream of the orifice.
B9. The method of any of the preceding embodiments, further comprising triggering illumination means for illuminating the particle in the object field.
B10. The method of any of the preceding embodiments, wherein sensing one or more optical signals of the one or more particles comprises illuminating the one or more particles with a laser and measuring at least one property of the laser after interaction with the one or more particles.
B11. The method of any of the preceding embodiments, further comprising sorting the cells with a cell sorter.
B12. The method of embodiment B10, wherein the at least one property is at least one of the following: front scatter, side scatter, or fluorescence.
B13. The method of any of the preceding embodiments, wherein sensing the one or more optical signals of the one or more particles comprises both capturing at least one image of the one or more particles with an imaging system and illuminating the one or more particles with a laser and measuring at least one property of the laser after interaction with the one or more particles with a cytometry sensor assembly.
B14. The method of any of the preceding embodiments, wherein the sensor assembly is a first sensor assembly, and further comprising sensing one or more optical signals of the one or more particles with a second sensor assembly after the one or more particles has been ejected from the orifice.
B15. The method of any of the preceding embodiments, wherein sensing one or more optical signals the one or more particles with a sensor assembly while one or more particles is upstream of the orifice comprises capturing at least one image of the one or more particles with an imaging system, and wherein sensing one or more optical signals of the one or more particles with a second sensor assembly while the after the one or more particles has been ejected from the orifice comprises illuminating the one or more particles with a laser and measuring at least one property of the laser after interaction with the one or more particles.
B12. The method of embodiment B11, further comprising triggering the imaging system with a one or more particles prior to capturing an image of the one or more particles with the imaging system.
C1. In a flow cytometer configured to eject a plurality of particles from an orifice of a nozzle, the improvement comprising a sensor assembly configured to measure one or more optical signals of a one or more particles of the plurality of particles while the one or more particles is disposed at or upstream of the orifice.
C2. The flow cytometer of embodiment C1, wherein the nozzle is configured to hydrodynamically focus the one or more particles prior to ejection from the orifice, and wherein the sensor assembly is configured to capture the one or more optical signals of the one or more particles after the one or more particles have been hydrodynamically focused, but before the one or more particles are ejected from the orifice.
C3. The flow cytometer any of the preceding embodiments, wherein the sensor assembly is configured to capture one or more optical signals of the one or more particles while the one or more particles are between 0 mm and 5 mm upstream of the orifice.
C4. The flow cytometer of any of the preceding embodiments, wherein the nozzle comprises a transparent or translucent member disposed upstream of the orifice, wherein the sensor assembly is configured to capture the one or more optical signals of the one or more particles through the transparent or translucent member.
C5. The flow cytometer of embodiment C4, wherein a surface of the transparent or translucent member is oriented approximately perpendicular to the direction of the flow path.
C6. The flow cytometer of any of embodiments C4-C5, wherein the transparent or translucent member is disposed at a proximal end of the nozzle opposite the orifice.
C7. The flow cytometer of any of embodiments C4-C6, wherein the transparent or translucent member is formed of either glass or plastic.
C8. The flow cytometer of any of the preceding embodiments, further comprising a trigger assembly configured to send a signal to a controller to actuate the sensor assembly.
C9. The flow cytometer of embodiment C8, wherein the trigger assembly is configured to send a signal to a controller to actuate the sensor assembly when a particle passes through a trigger field disposed upstream of the orifice.
C10. The flow cytometer of any of embodiments C8-C9, wherein the trigger assembly comprises a laser source and a laser sensor.
C11. The flow cytometer of any of the preceding embodiments, wherein the one or more particles comprises cells.
C12. The flow cytometer of any of the preceding embodiments, wherein the nozzle is substantially conical or wedge-shaped.
C13. The flow cytometer of any of the preceding embodiments, wherein the sensor assembly comprises an imaging system configured to capture at least one image of the one or more particles while the one or more particles are disposed at or upstream of the orifice.
C14. The flow cytometer of any of the preceding embodiments, wherein the imaging system is configured to capture the at least one image of the one or more particles as the one or more particles move from a foreground portion to a background portion of a depth of field of the imaging system.
C15. The flow cytometer of any of the preceding embodiments, wherein a focal plane of the imaging system is approximately perpendicular to the flow path.
C16. The flow cytometer of any of the preceding embodiments; wherein the imaging system is configured to capture one or more images of the one or more particles as they move through an object field disposed upstream of the orifice.
C17. The flow cytometer of any of the preceding embodiments, wherein the imaging system is configured to capture the one or more images as the one or more of the plurality of particles moves through a focal plane of the object field.
C18. The flow cytometer of any of the preceding embodiments, wherein the trigger field is disposed upstream of the object field.
C19. The flow cytometer of any of the preceding embodiments, wherein the trigger assembly is configured to trigger illumination means for illuminating the one or more particles in the object field.
C20. The flow cytometer of any of the preceding embodiments, wherein an interior surface of the nozzle cavity is configured to increase illumination of the object field.
C21. The flow cytometer of any of the preceding embodiments, wherein the interior portion of the nozzle cavity is white or reflective.
C22. The flow cytometer of any of the preceding embodiments, wherein the imaging system is configured to capture still images and/or video.
C23. The flow cytometer of any of the preceding embodiments, wherein the sensor assembly comprises a cytometry sensor assembly comprising a laser configured to interact with a particle of the plurality of particles while the particle is disposed at or upstream of the orifice, and at least one sensor configured to measure properties of the laser after interaction with the particle.
C24. The flow cytometer of embodiment C23, wherein the at least one property is at least one of the following: forward scatter, side scatter, and fluorescence.
C25. The flow cytometer of any of embodiments C23-C24, wherein the cytometry sensor assembly comprises a cell sorter.
C26. The flow cytometer of embodiment C25, wherein the cell sorter comprises a charge circuit providing an electrical charge to the fluid; a receptacle positioned to receive one or more cell containing drops formed from the fluid after ejection from the orifice; and a current detection circuit coupled to the receptacle and configured to measure a current in the receptacle.
C27. The flow cytometer any of the preceding embodiments, wherein the sensor assembly comprises both an imaging system configured to capture at least one image of the one or more particles, and a cytometry sensor assembly configured to measure one or more optical signals of the one or more particles.
C28. The flow cytometer any of the preceding embodiments, wherein the sensor assembly is a first sensor assembly, and wherein the flow cytometer further comprises a second sensor assembly configured to measure one or more optical signals of the one or more particles after the one or more particles have been ejected from the orifice.
C29. The flow cytometer of embodiment C28, wherein one of the first or second sensor assemblies is an imaging system configured to capture at least one image of the one or more particles when the one or more particles are disposed at or upstream of the orifice, and wherein the other of the first or second sensor assemblies comprises a cytometry sensor assembly configured to measure one or more optical signals of the one or more particles.
C30. The flow cytometer of embodiment C29, wherein the first sensor assembly is the imaging system, and the second sensor assembly is the cytometry sensor assembly.
C31. The flow cytometer of any of the preceding embodiments, wherein the flow path is oriented from a proximal end of the nozzle opposite the orifice through the orifice.
C32. The flow cytometer of any of the preceding embodiments, wherein the sensor assembly comprises an imaging system configured to capture images and/or videos of the one or more particles, wherein the imaging system is disposed at a proximal end of the nozzle opposite the orifice.

### D1. a Flow Cytometer Comprising:

a nozzle defining an interior volume and comprising an orifice at a distal end of the nozzle, the nozzle configured to eject fluid from the interior volume of the nozzle through the orifice along a flow path, the fluid comprising a plurality of particles; and
a sensor assembly disposed at a proximal end of the nozzle opposite the orifice, the sensor assembly configured to capture one or more optical signals of one or more of the particles.
   D2. The flow cytometer of embodiment D1, wherein the sensor assembly is configured to capture the one or more optical signals of one or more of the particles while the particles are upstream of or at the orifice.
   D3. The flow cytometer of embodiment D1, wherein the sensor assembly is configured to capture the one or more optical signals of one or more of the particles while the particles are downstream of the orifice.

D4. The flow cytometer of any of embodiments D1-D3, wherein the sensor assembly comprises an imaging system configured to capture one or more images of the particles.

D5. The flow cytometer of any of embodiments D1-D3, wherein the sensor assembly comprises a cytometry sensor assembly comprising a laser configured to interact with a particle of the plurality of particles, and at least one sensor configured to measure properties of the laser after interaction with the particle.

### EQUIVALENTS

While several inventive embodiments have been described and illustrated herein, those of ordinary skill in the art will readily envision a variety of other means and/or structures for performing the function and/or obtaining the results and/or one or more of the advantages described herein, and each of such variations and/or modifications is deemed to be within the scope of the inventive embodiments described herein. More generally, those skilled in the art will readily appreciate that all parameters, dimensions, materials, and configurations described herein are meant to be exemplary and that the actual parameters, dimensions, materials, and/or configurations will depend upon the specific application or applications for which the inventive teachings is/are used. Those skilled in the art will recognize, or be able to ascertain using no more than routine experimentation, many equivalents to the specific inventive embodiments described herein. It is, therefore, to be understood that the foregoing embodiments are presented by way of example only and that, within the scope of the appended claims and equivalents thereto, inventive embodiments may be practiced otherwise than as specifically described and claimed. Inventive embodiments of the present disclosure are directed to each individual feature, system, article, material, kit, and/or method described herein. In addition, any combination of two or more such features, systems, articles, materials, kits, and/or methods, if such features, systems, articles, materials, kits, and/or methods are not mutually inconsistent, is included within the inventive scope of the present disclosure.

All definitions, as defined and used herein, should be understood to control over dictionary definitions, definitions in documents incorporated by reference, and/or ordinary meanings of the defined terms.

All references, patents and patent applications disclosed herein are incorporated by reference with respect to the subject matter for which each is cited, which in some cases may encompass the entirety of the document.

The indefinite articles “a” and “an,” as used herein in the specification and in the claims, unless clearly indicated to the contrary, should be understood to mean “at least one.” The phrase “and/or,” as used herein in the specification and in the claims, should be understood to mean “either or both” of the elements so conjoined, i.e., elements that are conjunctively present in some cases and disjunctively present in other cases. Multiple elements listed with “and/or” should be construed in the same fashion, i.e., “one or more” of the elements so conjoined. Other elements may optionally be present other than the elements specifically identified by the “and/or” clause, whether related or unrelated to those elements specifically identified. Thus, as a non-limiting example, a reference to “A and/or B”, when used in conjunction with open-ended language such as “comprising” can refer, in one embodiment, to A only (optionally including elements other than B); in another embodiment, to B only (optionally including elements other than A); in yet another embodiment, to both A and B (optionally including other elements); etc.

As used herein in the specification and in the claims, “or” should be understood to have the same meaning as “and/or” as defined above. For example, when separating items in a list, “or” or “and/or” shall be interpreted as being inclusive, i.e., the inclusion of at least one, but also including more than one, of a number or list of elements, and, optionally, additional unlisted items. Only terms clearly indicated to the contrary, such as “only one of” or “exactly one of,” or, when used in the claims, “consisting of,” will refer to the inclusion of exactly one element of a number or list of elements. In general, the term “or” as used herein shall only be interpreted as indicating exclusive alternatives (i.e. “one or the other but not both”) when preceded by terms of exclusivity, such as “either,” “one of,” “only one of,” or “exactly one of.” “Consisting essentially of,” when used in the claims, shall have its ordinary meaning as used in the field of patent law.

As used herein in the specification and in the claims, the phrase “at least one,” in reference to a list of one or more elements, should be understood to mean at least one element selected from any one or more of the elements in the list of elements, but not necessarily including at least one of each and every element specifically listed within the list of elements and not excluding any combinations of elements in the list of elements. This definition also allows that elements may optionally be present other than the elements specifically identified within the list of elements to which the phrase “at least one” refers, whether related or unrelated to those elements specifically identified. Thus, as a non-limiting example, “at least one of A and B” (or, equivalently, “at least one of A or B,” or, equivalently “at least one of A and/or B”) can refer, in one embodiment, to at least one, optionally including more than one, A, with no B present (and optionally including elements other than B); in another embodiment, to at least one, optionally including more than one, B, with no A present (and optionally including elements other than A); in yet another embodiment, to at least one, optionally including more than one, A, and at least one, optionally including more than one, B (and optionally including other elements); etc.

It should also be understood that, unless clearly indicated to the contrary, in any methods claimed herein that include more than one step or act, the order of the steps or acts of the method is not necessarily limited to the order in which the steps or acts of the method are recited.

In the claims, as well as in the specification above, all transitional phrases such as “comprising,” “including,” “carrying,” “having,” “containing,” “involving,” “holding,” “composed of,” and the like are to be understood to be open-ended, i.e., to mean including but not limited to. Only the transitional phrases “consisting of” and “consisting essentially of”′ shall be closed or semi-closed transitional phrases, respectively, as set forth in the United States Patent Office Manual of Patent Examining Procedures, Section 2111.03. It should be appreciated that embodiments described in this document using an open-ended transitional phrase (e.g., “comprising”) are also contemplated, in alternative embodiments, as “consisting of” and “consisting essentially of” the feature described by the open-ended transitional phrase. For example, if the disclosure describes “a composition comprising A and B”, the disclosure also contemplates the alternative embodiments “a composition consisting of A and B” and “a composition consisting essentially of A and B”.

1.-85. (canceled)

86. A flow cytometer comprising:
a nozzle defining an interior volume and comprising an orifice at a distal end of the nozzle, the nozzle configured to eject fluid from the interior volume of the nozzle through the orifice along a flow path, the fluid comprising a plurality of particles; and
a sensor assembly configured to capture one or more optical signals of one or more of the plurality of particles while the one or more particles are disposed at or upstream of the orifice.

87. The flow cytometer of claim 86, wherein the nozzle is configured to hydrodynamically focus the one or more of the plurality of particles prior to ejection from the orifice, and wherein the sensor assembly is configured to capture the one or more optical signals of the one or more of the plurality of particles after the one or more of the plurality of particles have been hydrodynamically focused, but before the one or more of the plurality of particles are ejected from the orifice.

88. The flow cytometer of claim 86, wherein the sensor assembly comprises an imaging system configured to capture one or more images of the one or more of the plurality of particles.

89. The flow cytometer of claim 88, wherein the imaging system is configured to capture the one or more images of the one or more of the plurality of particles as the one or more of the plurality of particles move from a foreground portion to a background portion of a depth of field of the imaging system.

90. The flow cytometer of claim 86, wherein the sensor assembly is a first sensor assembly, and wherein the flow cytometer further comprises a second sensor assembly configured to measure one or more optical signals of the one or more of the plurality particles after the one or more of the plurality of particles have been ejected from the orifice.

91. The flow cytometer of claim 90, wherein one of the first or second sensor assemblies is an imaging system configured to capture at least one image of the one or more of the plurality of particles when the one or more of the plurality of particles are disposed at or upstream of the orifice, and wherein the other of the first or second sensor assemblies comprises a cytometry sensor assembly configured to measure one or more optical signals of the one or more of the plurality of particles.

92. The flow cytometer of claim 91, wherein the first sensor assembly is the imaging system, and the second sensor assembly is the cytometry sensor assembly.

93. The flow cytometer of claim 90, wherein one of the first sensor assembly or second sensor assembly comprises a cell sorter.

94. A flow cytometer comprising:
a nozzle defining an interior volume and comprising an orifice at a distal end of the nozzle, the nozzle configured to eject fluid from the interior volume of the nozzle through the orifice along a flow path, the fluid comprising a plurality of particles; and
a sensor assembly disposed at a proximal end of the nozzle opposite the orifice, the sensor assembly configured to capture one or more optical signals of one or more of the plurality of particles.

95. The flow cytometer of claim 94, wherein the nozzle comprises a transparent or translucent member disposed upstream of the orifice, wherein the sensor assembly is configured to capture the one or more optical signals of the one or more of the plurality of particles through the transparent or translucent member.

96. The flow cytometer of claim 95, wherein the transparent or translucent member is disposed at the proximal end of the nozzle.

97. The flow cytometer of claim 94, wherein the sensor assembly comprises an imaging system configured to capture at least one image of the one or more of the plurality of particles while the one or more of the plurality of particles are disposed at or upstream of the orifice.

98. The flow cytometer of claim 94, further comprising a trigger assembly configured to send a signal to a controller to actuate the sensor assembly when a particle passes through a trigger field disposed upstream of the orifice.

99. The flow cytometer of claim 98, wherein the trigger assembly is configured to trigger illumination means for illuminating the particle.

100. A method of measuring optical signals of particles, the method comprising:
moving fluid through a nozzle defining an interior volume and comprising an orifice at a distal end of the nozzle, the nozzle configured to eject fluid from the interior volume of the nozzle through the orifice along a flow path, the fluid comprising a plurality of particles;
capturing, using a sensor assembly, one or more optical signals of one or more of the plurality of particles while the one or more of the plurality of particles are at or upstream of the orifice; and
ejecting the one or more of the plurality of particles from the nozzle, through the orifice.

101. The method of claim 100, wherein capturing the one or more optical signals of the one or more of the plurality of particles comprises capturing at least one image of the one or more of the plurality of particles with an imaging system.

102. The method of claim 101, wherein capturing of the at least one image of the one or more of the plurality of particles occurs as the one or more of the plurality of particles moves from a foreground portion to a background portion of a depth of field of the imaging system.

103. The method of claim 101, further comprising triggering illumination means for illuminating the one or more of the plurality of particles when capturing the at least one image.

104. The method of claim 100, further comprising triggering the sensor assembly with the one or more of the plurality of particles prior to capturing the one or more optical signals of the one or more of the plurality of particles with the sensor assembly.

105. The method of claim 100, wherein sensing the one or more optical signals of the one or more of the plurality of particles comprises both capturing at least one image of the one or more of the plurality of particles with an imaging system and illuminating the one or more of the plurality of particles with a laser and measuring at least one property of the laser after interaction with the one or more of the plurality of particles with a cytometry sensor assembly.

106. In a flow cytometer configured to eject a plurality of particles from an orifice of a nozzle, the improvement comprising a sensor assembly configured to measure one or more optical signals of a one or more particles of the plurality of particles while the one or more particles is disposed at or upstream of the orifice.
